(19) United States
(12) Patent Application Publication
(10) Pub. No.: US 2014/0068438 A1
(43) Pub. Date: Mar. 6, 2014

(54) FAVORITES BAR FOR BROADCAST VIDEO PRODUCTION SYSTEMS

(71) Applicant: GVBB HOLDINGS S.A.R.L., Luxembourg (LU)

(72) Inventor: Mark S. HILLEBRANDT, Portland, OR (US)

(73) Assignee: GVBB HOLDINGS S.A.R.L., Luxembourg (LU)

(21) Appl. No.: 14/019,522

(22) Filed: Sep. 5, 2013

Related U.S. Application Data
(60) Provisional application No. 61/697,270, filed on Sep. 5, 2012.

(51) Int. Cl. G06F 3/0484

(52) U.S. Cl. CPC G06F 3/04842
USPC 715/719

(57) ABSTRACT

Methods and apparatus for managing multimedia content are provided. A method of managing broadcast video data may include providing an identifier corresponding to a video clip in a designated area of a display, retrieving the video clip in response to a selection of the identifier by an operator, and providing a video feed comprising the video clip to a broadcast video production system. The video clip may be managed by a video media server and derived from a live video feed received by the video media server from one or more cameras.

### CROSS-REFERENCE TO RELATED APPLICATION

This application claims priority to U.S. Provisional Patent Application No. 61/697,270, filed on Sep. 5, 2012.

### BACKGROUND

1. Field

The present disclosure relates generally to video production systems and, more particularly, to systems and methods for managing broadcast content.

2. Background

Video production systems used in, for example, television studios, or deployed at sporting events typically receive video and audio feeds from multiple cameras though various control, processing, routing and communications devices. Much of the equipment is networked and can communicate for control, monitoring and configuration purposes. Some or all of the equipment may be provisioned and configured to meet a variety of video formats, and to provide changing levels of functionality. In certain live broadcast environments, video media servers are employed to capture video feed from multiple sources, including cameras, and an operator can mark, extract and organize clips for instant replay and other purposes. Operators face many challenges in processing and managing video feeds in real-time.

### SUMMARY

In an aspect of the disclosure, a method of managing broadcast video data includes providing an identifier corresponding to a video clip in a designated area of a display, retrieving the video clip in response to a selection of the identifier by an operator, and providing a video feed comprising the video clip to a broadcast video production system. The video clip is managed by a video media server and derived from a live video feed received by the video media server from one or more cameras.

### BRIEF DESCRIPTION OF THE DRAWINGS

FIG. 1 is a diagram illustrating an example of a hardware implementation for an apparatus employing a processing system.

FIG. 2 is a block diagram illustrating an example of a video production system.

FIG. 3 is an illustration of a display screen of a display system included in the video production system of FIG. 2.

FIG. 4 is a flowchart illustrating an example method of managing broadcast video data at a video media server.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of video production systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, image processors, digital signal processors (DSPs), field programmable gate arrays (FPGAs), programmable logic devices (PLDs), state machines, gated logic, discrete hardware circuits, and other suitable hardware configured to perform the various functionalities described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium.

A computer-readable medium may include, by way of example, non-transitory storage such as a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, as well as a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

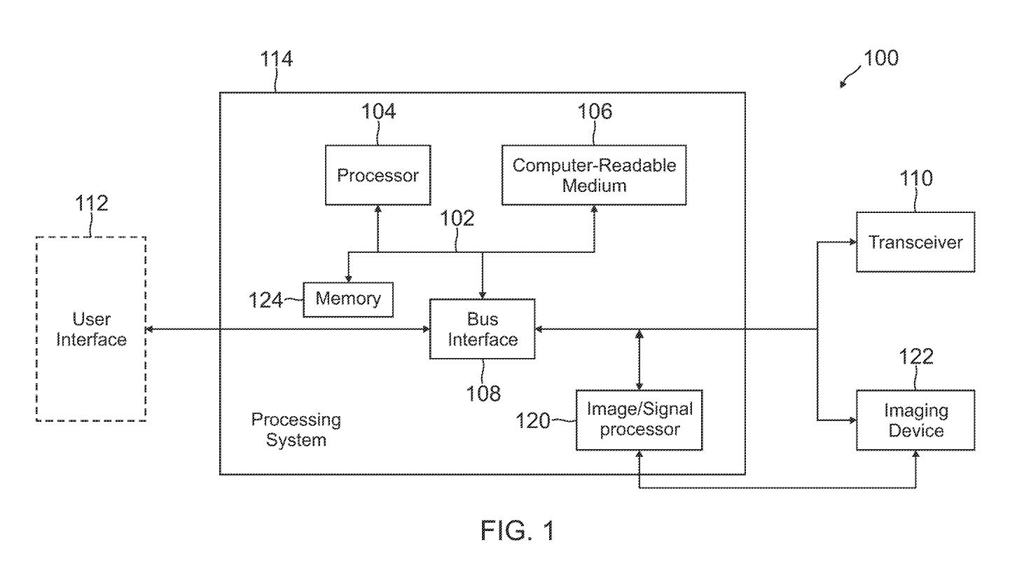

FIG. 1 is a conceptual diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104 and image/signal processor 120, non-transitory computer-readable media, represented generally by the computer-readable medium 106, and memory, represented generally by the memory 124. The bus 102 may also link various other circuits such as timing sources, peripherals, voltage regulators, and power management circuits, which are well known in the art, and therefore, will not be described any further.

In some embodiments, a bus interface 108 provides an interface between the bus 102 and a transceiver 110. The transceiver 110 provides a means for communicating with various other apparatus over a transmission medium. In some embodiments, the bus interface 108 may provide an interface between the bus 102 and an imaging device 122. The imaging device 122 may capture a sequence of images of a scene or event to enable the processing system 114 to produce a video feed. The image/signal processor 120 may be configured to operate on pixels in the sequence of images to produce a signal representative of one or more images captured by the imaging device 122. In one example, the processing system 114 may be incorporated in a camera, such that the imaging device 122 include a charge-coupled device (CCD) array or another device suitable for capturing images that provides a ‘raw’ image signal directly to the image/signal processor 120, which may process pixel information in a sequence of images to produce a standardized video output. In another example, the imaging device 122 may include a camera in which the image processor 120 may be employed to extract information from a signal transmitted by the imaging device 122. The extracted information may include a compressed video stream and metadata including background information, foreground objects, motion vectors, virtual lines, object counting, object tracking and other metadata. Depending upon the nature of the apparatus, a user interface 112 (e.g., keypad, display, speaker, microphone, and/or joystick) may also be provided.

The processor 104 may be responsible for managing the bus 102 and general processing, including the execution of software stored on the computer-readable medium 106. The software, when executed by the processor 104, may cause the processing system 114 to perform the various functions described infra for any particular apparatus. The computer-readable medium 106 may also be used for storing data that is manipulated by the processor 104 when executing software.

By way of example and without limitation, the aspects of the present disclosure illustrated in FIG. 1 are presented with reference to systems and methods used to configure components of a video production system that may be used for production of television programming or at sports events. The various concepts presented throughout this disclosure may be implemented across a broad variety of imaging applications, including systems that capture and process video and/or still images, video conferencing systems and so on. The various concepts presented throughout this disclosure may be applied to other equipment that may be communicatively coupled to components of a video production system, including, for example, smart phones and tablet computers, as well as other computing platforms.

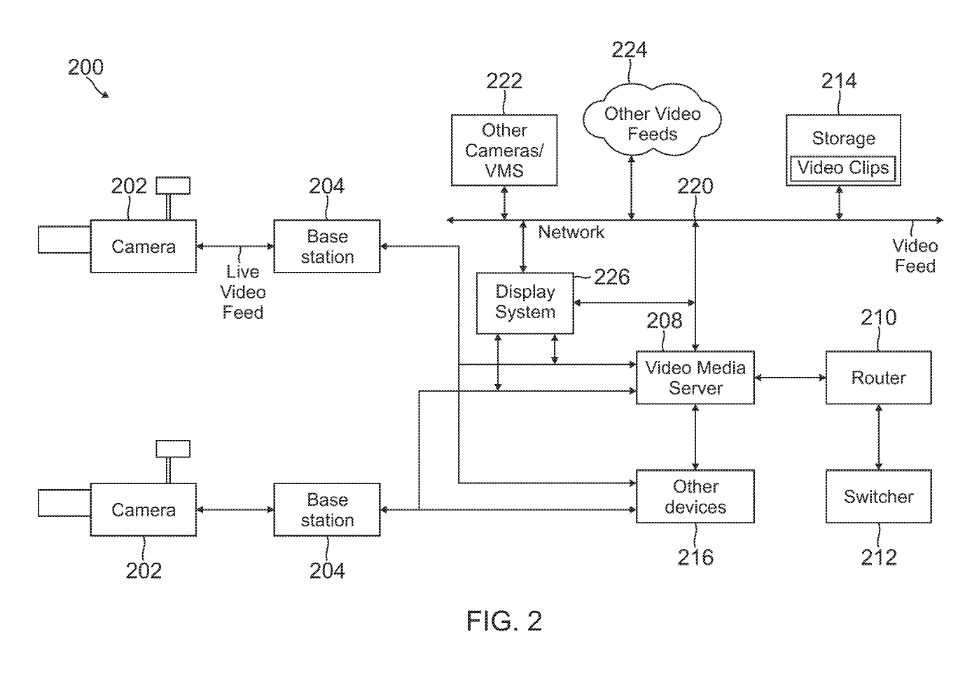

FIG. 2 is a block diagram illustrating a video production system 200. As described herein, a video production system may include a variety of components, which may have multiple features and perform a variety of functions. The drawings depict only certain components to facilitate description of certain aspects of the invention. The video production system 200 may include one or more cameras 202 deployed to capture video images of a scene or event. The video production system 200 may include one or more display systems 226. The one or more display systems 226 may have interconnectivity to one or more of the network, the base stations 204, video media server 208, and/or other devices 216. At a sporting event, for example, many cameras may be deployed in order to capture video from multiple angles. The cameras 202 typically include a processing system that produces an encoded video output representative of a sequence of images captured by the imaging device 122. For the purposes of this description, video feeds and other signals are represented as being transmitted to downstream devices by the cameras 202 and/or the base stations 204. Control, command and other signals received by the camera 202, including audio signals directed to an operator, may be referred to as upstream signals, as are any other signals transmitted in the general direction of the camera 202.

In some embodiments, the camera 202 may be connected to a base station 204.

The base station 204 may provide power and communications services for the camera 202 and may enable, for example, transmission of the camera output over long distances. The base station 204 may support other functions including, for example, configuration, intercom, a variety of audio and other communications systems, teleprompter systems, and/or video processing on behalf of the camera 202.

The base station 204 may control and monitor the operation of one or more cameras 202. The base station 204 may support standard or proprietary control interface protocols and support various different camera types through a single command interface. The base station 204 may be used to configure and coordinate sets of the cameras 202 and may provide a communications channel for transferring operational parameters between the cameras 202. The base station 204 may capture a configuration for one or more of the cameras 202 as a scene configuration. The base station 204 may store the scene configuration and/or share the scene configuration with other system components. The scene configuration may be used at a later time to restore settings of the camera 202 and/or restore other controllable features of the system. The base station 204 may cause the cameras 202 to perform diagnostics and may provide status information of the cameras 202 to one or more downstream devices.

In the example illustrated in FIG. 2, the video production system 200 includes a video media server 208 that receives video feeds from the cameras 202 and/or from the base stations 204. The video media server 208 may receive the video feeds at approximately the same time the signals are received by other components 216 of video production system 200, including mixing and production stations. In some instances, the video media server 208 may receive video feeds from one or more other components 216, which may provide a processed version of the video feed. The video media server 208 is typically provided a number of primary feeds which are managed and processed by an operator. In one example, the video media server 208 may be adapted to receive six or more video feeds.

In some embodiments, the video media server 208 may receive feeds from additional sources, including sources accessible through a network, which may be provided via Ethernet connectivity 220. Additional sources may include other cameras 202 and/or the video media servers 222 deployed at a sporting event. For example, eighteen or more of the cameras 202 may be deployed at a football game, and three or more of the video media servers 208 may be used to process video provided by the cameras 202. In some embodiments, an operator of the video media server 208 may have access to all feeds generated by the eighteen cameras 202. It will be appreciated that, in some embodiments, primary video feeds may also be provided over a network. In some embodiments, other video feeds 224 may be provided from remote sources through a wide area network, such as the Internet.

One or more communications devices may serve as communications gateways and/or routers to deliver outputs generated by the video media server 208. Outputs may include highlight clips, replays, slow-motion, and other content generated from video feeds received by the video media server 208.

A router 210 may be used to support the transmission of video feeds within the video production system 200. The router 210 may be configured to receive video feeds from one or more cameras 202 and/or video media servers 208. Further, the router 210 may be further configured to provide some combination of those feeds to downstream components through a switcher 212. The storage 214 may include any audio/video recording device suitable for capturing, storing, replaying and/or forwarding video and audio feeds produced or used by a video production system, and may be implemented in one or more servers connected by a network to video media server 208. The switcher 212 may provide video and audio feeds to one or more production systems and/or transmission systems, such as microwave transmission systems. The router 210 may receive video for broadcast and may provide broadcast feeds to broadcast networks, the video storage systems 214 and/or other devices 216, such as network streaming servers.

In some embodiments, an operator of the video media server 208 may identify segments of video feed to be used for highlight, replay and other purposes. Clips may be generated from live video feed by marking the beginning and end of an action, play, etc. Clips may also include segment introductions, station identifications, network logos and other audio-video clips used in production. An operator of the video media server 208 may generate and manage large numbers of clips during a broadcast event and must typically provide rapid response to requests for individual clips and other material. The operator may manage multiple outputs of the video media server 208, including two or more video feeds to production desks, outputs to storage devices and communication links to other video media servers 208.

Certain embodiments provide an interactive system for managing multimedia clips and data streams at the video media server 208. The interactive system may be implemented in a combination of hardware and software. The interactive system may permit an operator to select a desired clip by touch screen selection and may provide mechanical controls that manipulate characteristics of selected clips. For example, slow-motion instant replay may be controlled by an operator using one or more of a T-bar or a detended wheel and a tactile wheel to obtain fast and accurate control of slow motion speed.

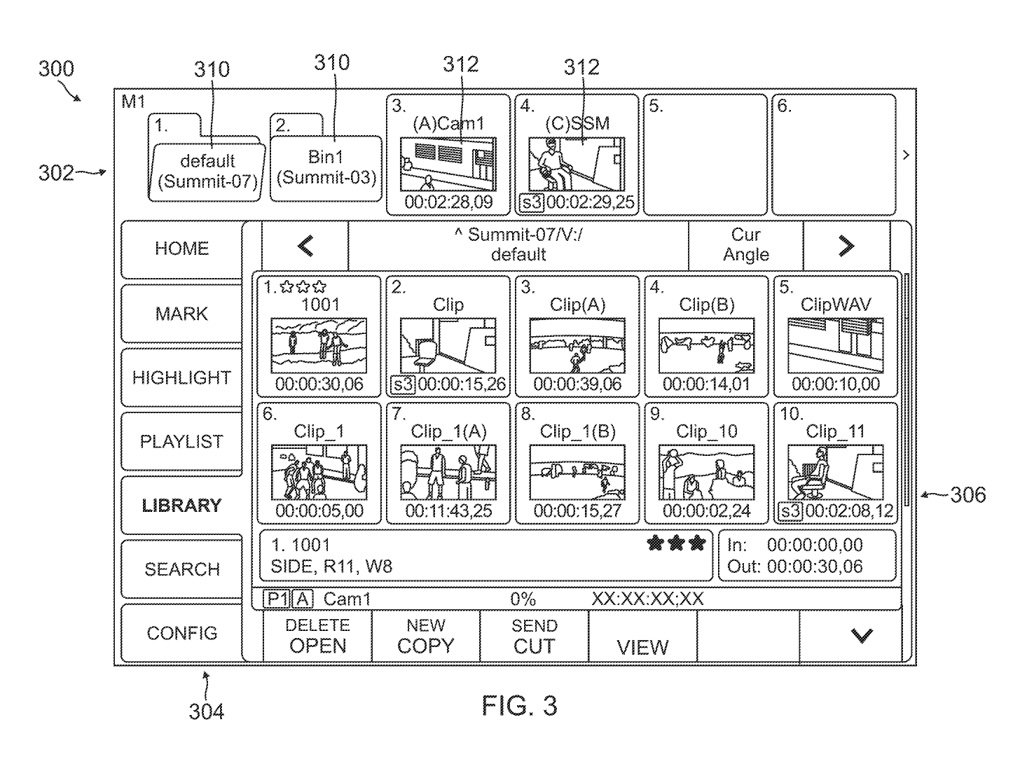

With reference to FIG. 3, some embodiments provide a favorites bar 302 on a display 300, or other display system that provides easy access to material and data files that are commonly used or expected to be requested within a short period of time. For example, the display 300 may be a touch screen display. The favorites bar 302 may be arranged in any manner on the display 300. In the example illustrated in FIG. 3, an operator may select the main display 306 to show one of a plurality of optional display types listed at left side 304 of the display 300. As illustrated in FIG. 3, the current display shows selections from a library. Other options include a playlist, highlights, marked clips and search results. Data, including video clips may be added to the library, playlist, highlights, and/or marked clips by the operator through association made on the screen and/or through metadata created or added by the operator.

The favorites area 302 may include one or more icons and/or thumbnails representative of the clips 312 and/or the bins 310. The bins 310 may be considered to be a multimedia equivalent of folders, and typically group and contain combinations and/or collections of video clips. In some embodiments, the bin 310 may contain one or more other bins. Icons and thumbnails representing video clips in the favorites area 302 and the bins 310 may be linked to the underlying data files in storage that is directly accessible by the video media server 208. An operator may add video clips to the favorites area 302 while processing live video feeds. An operator may add video clips to the favorites area 302 from a library, search results, a list of highlights, and/or other icons or thumbnails.

In some embodiments, an operator of one of the video media server 208 may tag or otherwise add a link to a segment or clip of a video feed that is managed and processed by another video media server (VMS) 222 (see FIG. 2). The segment or clip may be represented on the display in the same manner as locally managed and/or stored video clips, although the video clip may be stored remotely and may be accessible only through another system component. When a remotely managed clip is to be used at the VMS 208, the operator may activate the clip in the favorites area 302, thereby causing a local VMS 208 to access the desired data file through a different VMS 222 and/or via a remote storage device. The local VMS 208 may download and/or create a local copy of the desired data file.

In certain embodiments, an operating system is provided to manage system hardware and software components. The operating system may permit an operator access to content from organizational bins, search bins, repository bins, network connected devices, network connected folders, and network connected content. Access may include placing clip content and/or retrieving clip content through a user interface that may support one or more of drag and drop, copy and paste, and/or cut and paste. Touch screen finger gesturing allows for hide or reveal of the favorites bar 302. The favorites bar 302 may remain revealed without impeding functionality or access to other operational aspects of the user interface. The favorites bar 302 may have its own access pane to allow an operator to organize content and establish order. There is typically no limit placed on the number of items placed in the favorites bar 302 and items may be added or removed to the favorites bar 302 at any time.

Navigation to commonly used network devices is facilitated, and the need for access to commonly used folders and clip content may be satisfied. Moreover, operators can easily access a catalogue of content, even when limitations on the amount of content to be stored in various locations are removed. Accordingly, aspects of the invention provide major time savings in sharing or fetching content between network-connected devices. User experience is improved, as is speed of access with respect to desired content.

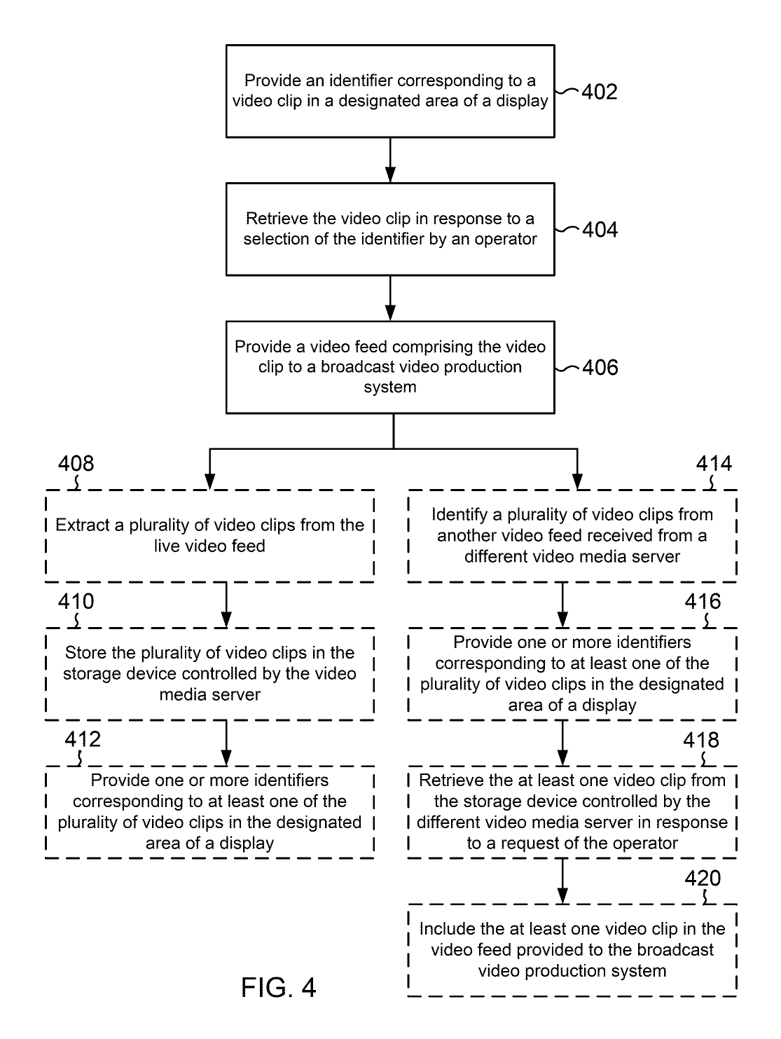

FIG. 4 is a flowchart illustrating an example method of managing broadcast video data at a video media server. The method may be performed by an apparatus, such as a video production system or any similar device having a processing system. At 402, the apparatus may provide an identifier corresponding to a video clip in a designated area of a display. At 404, the apparatus may retrieve the video clip in response to a selection of the identifier by an operator. At 406, the apparatus may provide a video feed comprising the video clip to a broadcast video production system.

In some embodiments, at 408, the apparatus may extract a plurality of video clips from the live video feed. At 410, the apparatus may store the plurality of video clips in the storage device controlled by the video media server. At 412, the apparatus may provide one or more identifiers corresponding to at least one of the plurality of video clips in the designated area of a display.

In some embodiments, at 414, the apparatus may identify a plurality of video clips from another video feed received from a different video media server. At 416, the apparatus may provide one or more identifiers corresponding to at least one of the plurality of video clips in the designated area of a display. At 418, the apparatus may retrieve the at least one video clip from the storage device controlled by the different video media server in response to a request of the operator. At 420, the apparatus may include the at least one video clip in the video feed provided to the broadcast video production system.

The aforementioned systems and methods may employ one or more processing system 114 configured to perform the functions recited by the aforementioned systems and methods. As described supra, the processing system 114 may include processor 104 and image/signal processor 120. As such, in one configuration, the aforementioned systems and methods may be the processor 104 and image or signal processor 120 configured to perform the functions recited by the aforementioned systems and methods. Further, an apparatus (not shown) may be a physical structure configured to perform various functions. The apparatus may be a machine or system. The apparatus may include a processing system. The processing system may include a processor connected to non-transitory computer-readable medium and configured to execute software stored on the non-transitory computer-readable medium. The non-transitory computer-readable medium may also be used for storing data that is manipulated by the processor when executing software. The apparatus may have various mechanical, hardware, and/or software modules that are specifically configured to perform the stated processes/algorithms described herein.

For example, the apparatus may provide a means for providing an identifier corresponding to a video clip in a designated area of a display. The apparatus may also provide a means for retrieving the video clip in response to a selection of the identifier by an operator. The apparatus may also provide a means for providing a video feed comprising the video clip to a broadcast video production system.

In some embodiments, the video clip is managed by a video media server and derived from a live video feed received by the video media server. The apparatus may also provide a means for extracting a plurality of video clips from the live video feed. The apparatus may also provide a means for storing the plurality of video clips in the storage device controlled by the video media server. The apparatus may also provide a means for providing one or more identifiers corresponding to at least one of the plurality of video clips in the designated area of a display. The apparatus may also provide a means for identifying a plurality of video clips from another video feed received from a different video media server. The apparatus may also provide a means for providing one or more identifiers corresponding to at least one of the plurality of video clips in the designated area of a display. The apparatus may also provide a means for retrieving the at least one video clip from the storage device controlled by the different video media server in response to a request of the operator. The apparatus may also provide a means for including the at least one video clip in the video feed provided to the broadcast video production system.

The aforementioned means may employ one or more processing system 114 configured to perform the functions recited by the aforementioned means. As described supra, the processing system 114 may include processor 104 and image/signal processor 120. As such, in one configuration, the aforementioned means may be the processor 104 and image or signal processor 120 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method of managing broadcast video data, the method comprising:
providing an identifier corresponding to a video clip in a designated area of a display;
retrieving the video clip in response to a selection of the identifier by an operator; and
providing a video feed comprising the video clip to a broadcast video production system,
wherein the video clip is managed by a video media server and derived from a live video feed received by the video media server.

2. The method of claim 1, wherein one or more bins are provided in the designated area, wherein each bin is adapted to contain one or more video clips.

3. The method of claim 1, wherein the video clip is stored locally in a storage device controlled by the video media server.

4. The method of claim 3, further comprising:
extracting a plurality of video clips from the live video feed;
storing the plurality of video clips in the storage device controlled by the video media server; and
providing one or more identifiers corresponding to at least one of the plurality of video clips in the designated area of a display.

5. The method of claim 4, wherein the video feed is received from one or more video cameras associated with the video media server.

6. The method of claim 1, wherein the video clip is stored remotely in a storage device controlled by a different video media server.

7. The method of claim 6, further comprising:
identifying a plurality of video clips from another video feed received from a different video media server; and
providing one or more identifiers corresponding to at least one of the plurality of video clips in the designated area of a display.

8. The method of claim 7, wherein the one or more identifiers identify a storage location for each of the at least one video clip.

9. The method of claim 8, further comprising:
retrieving the at least one video clip from the storage device controlled by the different video media server in response to a request of the operator; and
including the at least one video clip in the video feed provided to the broadcast video production system.

10. The method of claim 9, wherein the another video feed is received from one or more video cameras associated with the different video media server.

11. An apparatus for managing broadcast video data, the apparatus comprising:
means for providing an identifier corresponding to a video clip in a designated area of a display;
means for retrieving the video clip in response to a selection of the identifier by an operator; and
means for providing a video feed comprising the video clip to a broadcast video production system,
wherein the video clip is managed by a video media server and derived from a live video feed received by the video media server.

12. The apparatus of claim 11, wherein one or more bins are provided in the designated area, wherein each bin is adapted to contain one or more video clips.

13. The apparatus of claim 11, wherein the video clip is stored locally in a storage device controlled by the video media server.

14. The apparatus of claim 13, further comprising:
means for extracting a plurality of video clips from the live video feed;
means for storing the plurality of video clips in the storage device controlled by the video media server; and
means for providing one or more identifiers corresponding to at least one of the plurality of video clips in the designated area of a display.

15. The apparatus of claim 14, wherein the video feed is received from one or more video cameras associated with the video media server.

16. The apparatus of claim 11, wherein the video clip is stored remotely in a storage device controlled by a different video media server.

17. The apparatus of claim 16, further comprising:
means for identifying a plurality of video clips from another video feed received from a different video media server; and
means for providing one or more identifiers corresponding to at least one of the plurality of video clips in the designated area of a display.

18. The apparatus of claim 17, wherein the one or more identifiers identify a storage location for each of the at least one video clip.

19. The apparatus of claim 18, further comprising:
means for retrieving the at least one video clip from the storage device controlled by the different video media server in response to a request of the operator; and
means for including the at least one video clip in the video feed provided to the broadcast video production system.

20. The apparatus of claim 19, wherein the another video feed is received from one or more video cameras associated with the different video media server.

21. A processing system comprising a memory and configured to:
provide an identifier corresponding to a video clip in a designated area of a display;
retrieve the video clip in response to a selection of the identifier by an operator; and
provide a video feed comprising the video clip to a broadcast video production system,
wherein the video clip is managed by a video media server and derived from a live video feed received by the video media server.
